(19) United States
(12) Patent Application Publication
(10) Pub. No.: US 2026/0078042 A1
(43) Pub. Date: Mar. 19, 2026

(54) AUTOMATIC GOB FORMING PROCESS PARAMETER DETERMINATION

(71) Applicant: Owens-Brockway Glass Container Inc., Perrysburg, OH (US)

(72) Inventors: Jessica Bryant, Sylvania, OH (US); Josh Peeno, Maumee, OH (US)

(21) Appl. No.: 19/332,003

(22) Filed: Sep. 17, 2025

Related U.S. Application Data
(60) Provisional application No. 63/695,835, filed on Sep. 17, 2024.

(51) Int. Cl. C03B 5/24

(52) U.S. Cl. CPC C03B 5/245

(57) ABSTRACT

A system for and method of determining process parameters for a gob forming subsystem are disclosed. Upstream sensor data, representing information captured by one or more sensors installed upstream of a feeder of the gob forming subsystem, are obtained. One or more gob forming process parameters are determined as a result of executing an artificial intelligence (AI) model that takes, as input, the upstream sensor data and that generates, as output, process parameter data representing the one or more gob forming process parameters.

### BACKGROUND

The glass container manufacturing process encompasses several critical stages, each integral to producing high-quality glass containers utilized across various sectors, including food and beverage, pharmaceuticals, and more. The process initiates with the melting of raw materials, such as in a furnace or submerged combustion melter, for example, (referred to generally as “glass melter apparatus”) to generate molten glass, conditioning of the molten glass in a forehearth, and producing gobs of the molten glass typically through a device known as a feeder. The molten glass gobs are subsequently formed, shaped, and cooled into the final glass containers.

The initial stages of the hot end of glass container manufacturing include gob forming, which typically involves the steps pertaining to the glass melter apparatus, the forehearth, and the feeder mentioned above, transforming raw materials into molten glass gobs (or simply “gobs”). The gobs are often then transported to a blank mold, which is used to form a parison that is then placed in a blow mold in order to form a glass container. The shape and size of the gob exert a direct influence on the quality of the final glass container. Consistent gob formation is important for achieving uniform and defect-free products, as proper gob formation ensures that the gobs are appropriately sized and shaped to fit into the forming machine, thereby facilitating efficient shaping and cooling processes.

Several factors contribute to the challenges in achieving and maintaining the desired gob shape and size. For example, variations in glass melter apparatus (e.g., a temperature measured within the furnace or melter) and the viscosity of molten glass present significant challenges in maintaining consistent gob formation. Further, for example, over time, mechanical components of the feeder or other equipment used for gob forming can experience wear and tear, leading to inconsistencies in gob formation. Differences in the composition of raw materials, as well as environmental factors such as ambient temperature and humidity, can also affect gob formation.

Managing gob formation is a specialty task that is conventionally performed by a specialist human operator, often relying on “gut feel” learnt through experience. Nonetheless, achieving consistent gob characteristics under varying conditions remains challenging even for experienced operators, which often can spend hours meticulously making adjustments to the feeder to achieve the desired size and shape gob.

### SUMMARY OF THE DISCLOSURE

In accordance with aspects of the present disclosure, a system for and method of determining process parameters for a gob forming subsystem of a glass container manufacturing system include obtaining upstream sensor data representing information captured by one or more sensors installed upstream of a feeder of the gob forming subsystem, and determining one or more gob forming process parameters as a result of executing a machine learning (ML) model that takes, as input, the upstream sensor data and that generates, as output, process parameter data representing the one or more gob forming process parameters. The presently disclosed system and method address, and may solve, problems with forming consistent gobs, for example, by providing a machine learning approach configured to maintain consistent gob size and shape despite variations in molten glass viscosity, equipment wear, raw material composition, and environmental factors. This approach may thus reduce dependency on specialist human operators'subjective adjustments, thereby minimizing time-consuming manual interventions and enhancing overall process reliability. As a result, the presently disclosed system and method may facilitate production of uniform, defect-free glass containers, thereby improving efficiency and quality in the manufacturing process.

### BRIEF DESCRIPTION OF THE DRAWINGS

FIG. 1 is a block diagram of a gob forming process parameter determination system in accordance with an illustrative embodiment of the present disclosure.

FIG. 2 is a schematic diagram of a glass container manufacturing system in accordance with an illustrative embodiment of the present disclosure.

FIG. 3 is a block diagram of a machine language model training system in accordance with an illustrative embodiment of the present disclosure.

FIG. 4 is a flow chart of a method of determining one or more process parameters for a gob forming subsystem in accordance with an illustrative embodiment of the present disclosure.

### DETAILED DESCRIPTION

In general, the present disclosure describes technology for determining process parameters for a gob forming subsystem of a glass container manufacturing system. In particular, an artificial intelligence (AI) model (specifically, a machine learning (ML) model, at least in some embodiments) is configured to take, as input, information from an upstream sensor of the gob forming subsystem, and generate an output indicating one or more process parameter(s) for the gob forming subsystem. The upstream sensor provides information pertaining to physical properties or aspects of the gob forming subsystem (and/or its environment) (e.g., temperature of molten glass in the glass melter apparatus and/or in the forehearth) prior to the gob being formed, enabling adjustments to gob formation anticipatorily through determining updated gob forming process parameter(s) using the upstream data in conjunction with the AI model.

The process parameter(s) are used for adjusting the gob forming process of the gob forming subsystem so as to effect a physical change in gob formation or makeup of gobs produced by the gob forming subsystem. According to embodiments, the process parameter(s) are then displayed or otherwise communicated to an operator, who may then consider and implement the process parameters. Alternatively, in embodiments, the process parameter(s) are used for automatically adjusting gob formation of the gob forming subsystem, such as through providing process control data to a gob forming subsystem controller, which may be any controller of the gob forming subsystem that has a controllable output controllable for effecting a physical change in gob formation, such as, for example, a feeder orifice heater controller or a plunger stroke controller of a feeder.

In some embodiments, the process parameter(s) are displayed or otherwise communicated to an operator and are also provided to a gob forming subsystem controller. In some embodiments, the process parameter(s), which are determined as a result of the AI model (e.g., ML model) processing the inputted upstream sensor information, are presented (e.g., using a computer display screen on an electronic monitor) to an operator as recommended parameter(s) for the gob forming subsystem; in such embodiments, the operator may then make adjustments and/or confirm to use and implement the process parameter(s) for the gob forming subsystem, which may cause the process parameter(s) and/or data based thereon to be implemented by one or more gob forming subsystem controller(s). In one of such embodiments, the gob forming process parameter(s) are sent to the gob forming subsystem, but are not implemented until an operator provides the “go ahead”or otherwise confirms to use the process parameter(s).

In some embodiments, in addition to taking, as input, upstream sensor data (i.e., data representing information captured by one or more upstream sensors of the gob forming process), the AI model also takes, as input, one or more physical gob formation attributes, such as, for example, gob weight, gob length, gob width, gob diameter, gob surface temperature, gob viscosity, gob velocity, gob acceleration, and/or gob drop angle. The one or more physical gob formation attributes are determined based on gob formation sensor data captured by a gob formation sensor, which is a sensor that captures information regarding physical attributes of a gob; for example, a vision system (including a camera and/or an infrared (IR) sensor) is used to capture images or other sensor data of the gob, which is then used for determining the one or more physical gob formation attributes.

In some embodiments, batch composition data, which is data indicating composition of batch materials used for forming molten glass, is used as input into the AI model, in addition to the upstream sensor data and/or the gob formation sensor data or information (e.g., raw gob formation sensor data, gob measurements based on the sensor data). The batch materials for glass container manufacturing typically include raw materials (e.g., sand, soda ash, limestone, and various other non-glass materials) and cullet. In one embodiment, the batch composition data includes the percentage of cullet in the batch material, and this percentage may be known ahead of time and inputted into the system by a user.

As discussed in the background, achieving consistent gob characteristics under varying conditions remains challenging even for experienced operators. Unfortunately, upstream conditions on the line could change causing a downstream effect on the gob size/shape, requiring an operator to spend additional time making adjustments to the feeder. This is a continuous cycle, and requires operators with experience that understand which adjustments to make given certain conditions—this is partially what is referred to when people say glass making is an art, not a science. In order to bring more science, reliability, and repeatability to the process, artificial intelligence (AI) can be used to develop models that will automatically make adjustments to the feeder to achieve and maintain a desired gob shape and size. An operator can tell the AI the desired gob characteristics, and based on the current conditions upstream and at the feeder, the AI can either inform the operator what adjustments to make, or ideally, automatically make the adjustments on behalf of the operator.

Leveraging artificial intelligence or machine learning (ML) to determine the specific adjustments to make based on current conditions will reduce the amount of time it takes to achieve the desired gob shape and size, as well as allow for the desired shape and size to be maintained with less operator intervention and briefer excursions out of tolerance as upstream conditions fluctuate, at least according to implementations. This has the potential to reduce the amount of ware that is either out of spec, or less than ideal, thus making job runs shorter because the amount of ware required for the order will be achieved sooner, as well as reduce the time operators need to focus on making feeder adjustments, freeing them up for other tasks.

In addition to these process and product improvements, the ML may also choose to make different adjustments than an operator would resulting in a more efficient process. For example, currently operators each have their own “favorite” set of parameters to adjust when trying to achieve a given gob shape/size. According to embodiments, the ML will not favor parameters, and will assess current conditions and make adjustments that are the most logical and will achieve the desired result soonest. This may include changes an operator would make on their own, but could also include changes to parameters that previously were ignored or relied on less heavily.

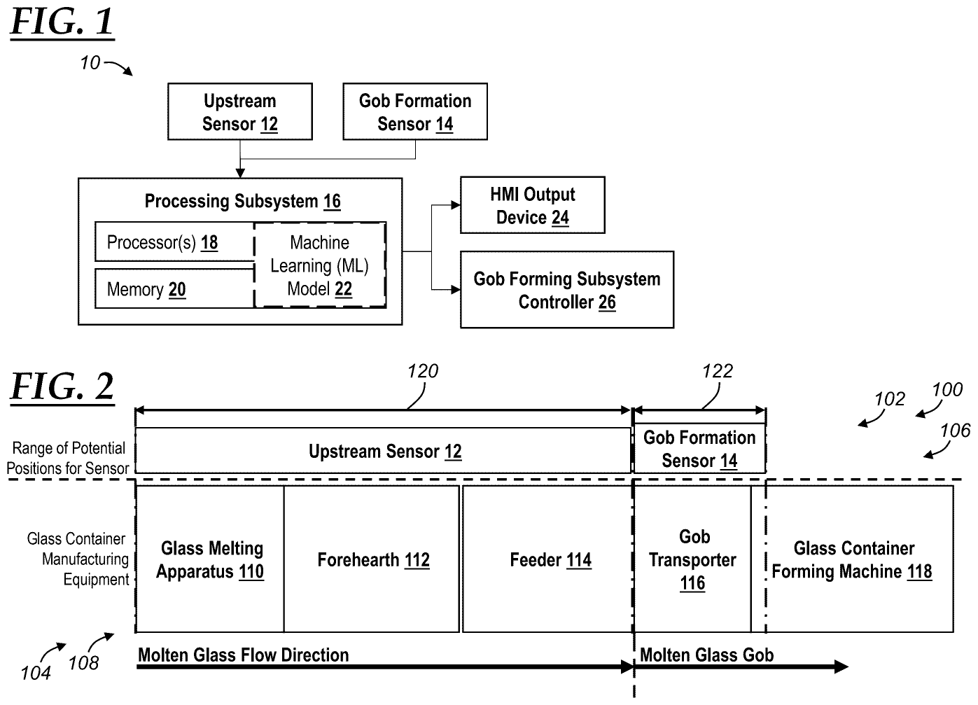

More specifically, and turning now to the drawings, FIG. 1 depicts a gob forming process parameter determination system 10, according to one embodiment. The gob forming process parameter determination system (or, simply, “system 10”) includes an upstream molten glass sensor (or, simply, upstream sensor) 12, a gob formation sensor 14, a processing subsystem 16 having at least one processor 18 and memory 20 storing computer instructions along with a machine learning (ML) model 22 (which is stored in the memory 20 and executed by the at least one processor 18), a human-machine interface (HMI) output device 24 for communicating process parameter(s) determined by the processing subsystem 16 to an operator, and a gob forming subsystem controller 26 for receiving process parameter(s) determined by the processing subsystem 16 and causing a gob forming subsystem to operate according to the process parameter(s).

The upstream sensor 12 is a sensor that is configured to capture information of a gob forming subsystem during its processing prior to molten glass being separated into gobs, such as a result of molten glass being sheared by a feeder of the gob forming subsystem. The upstream sensor 12 may be configured to capture sensor data of physical properties of molten glass in the gob forming subsystem (e.g., in or at the glass melting apparatus, in or at the forehearth, in or at the feeder), physical properties of upstream manufacturing equipment (e.g., furnace ambient temperature), and/or environmental properties of a gob forming subsystem.

With reference to FIG. 2, there is shown an embodiment of a glass container manufacturing system 100, which includes a hot end 102 comprised of a gob forming subsystem 104 and a glass container forming subsystem 106, and a cold end that is not shown in the depicted embodiment of FIG. 2. FIG. 2 represents an embodiment of a potential glass container manufacturing system 100 and, particularly, gob forming subsystem 104 incorporating the gob forming process parameter determination system 10 of FIG. 1. Underneath the horizontal, dashed line of FIG. 2, there is schematically depicted equipment 108 used for gob formation (referred to as gob formation equipment 108), including a glass melting apparatus 110, a forehearth 112, and a feeder 114. The term “glass melting apparatus” refers to a furnace, submerged combustion melter, or other suitable equipment or device for generating molten glass. The gob forming subsystem 102 includes the gob formation equipment 108 (the glass melting apparatus 110, the forehearth 112, and the feeder 114), and the glass container forming subsystem 104 includes a gob transporter 116 and a glass container forming machine 118 that forms glass containers out of gobs received thereat from the gob transporter 116. FIG. 2 also depicts a bold, horizontal arrow that shows the general direction of processing (direction in which product is processed to form glass gobs and containers), which generally proceeds from left to right in FIG. 2; a vertical, dashed line indicates a transition from contiguous molten glass to separate, individual gobs.

Further, above the horizontal, dashed line of FIG. 2, there is schematically depicted a range 120 of positions that are suitable for the upstream sensor 12 and a range 122 of positions (relative to the positioning along the molten glass flow direction or gob transport direction) that are suitable for the gob formation sensor 14. For instance, the upstream sensor 12 may be located at the glass melting apparatus 110, such as when the upstream sensor 12 is a thermometer or temperature measurement device of the glass melting apparatus 110; as another example, the upstream sensor 12 is a temperature measurement device that is configured to measure the temperature of molten glass entering the feeder 114, at an orifice of the feeder 114, or other position within or proximate the feeder 114; and, in yet another example, the upstream sensor 12 is a molten glass flow measurement device or a molten glass level gauge that provides a molten glass level of molten glass at an exit of the glass melting apparatus 110, within or at an exit of the forehearth 112, and/or within a feeder bowl of the feeder 114 or other portion of the feeder 114.

In some embodiments, the upstream sensor 12 is a feeder sensor, which is a sensor used by the feeder and/or at the feeder to measure operational information (e.g., plunger position, shear blade position) of the feeder and/or molten glass at the feeder prior to gob formation (e.g., molten glass level in feeder bowl, temperature of molten glass at entrance to the feeder 114). For example, in one embodiment, the upstream sensor 12 is a plunger stroke sensor that detects the position and/or movement of the plunger in the feeder 114. And, in another embodiment, the upstream sensor 12 is a shear cutter position sensor that monitors the timing and alignment of the shear blades responsible for cutting the gobs. And, in yet another embodiment, the upstream sensor 12 is a flow rate sensor of the feeder 114, such as one that monitors the flow of molten glass into the feeder.

Referring back to FIG. 1, but with continued reference to FIG. 2, the gob formation sensor 14 is a sensor that is used for measuring physical shape, form, and/or other physical attributes of a gob (“gob formation”), such as, for example, gob weight, gob length, gob width, gob diameter, gob surface temperature, gob viscosity, gob velocity, gob acceleration, and/or gob drop angle. As used herein, a “gob drop angle,” when used in connection with a gob, is an angle (relative to gravity) of an axial bottom end portion of the gob.

In the present embodiment, the gob formation sensor 14 is a vision system comprised of one or more cameras and/or one or more infrared (IR) sensors, and is used for remotely capturing physical attributes of a gob, such as through image capture and processing, for example. The gob formation sensor 14 is installed within the range 122 shown in FIG. 2, which is shown as being a range extending from an exit of the feeder 114 to an entrance or initial portion of the glass container forming machine 118, before being molded into a parison by a blank mold of the glass container forming machine 118.

In some embodiments, other aspects of the gob may be determined by a gob loading sensor (not shown) that determines gob loading position, gob arrival time, etc. For example, the gob sensors (16a, b) of U.S. Patent Application Publication No. 2023/0148131, which is hereby incorporated by reference in its entirety, may be used at the gob formation sensor 14 and/or the gob loading sensor.

The upstream sensor data captured by the upstream sensor 12, the gob formation sensor data captured by the gob formation sensor 14, and other sensor may be stored in a non-transitory, computer-readable memory, such as the memory 20 of the processing subsystem 16. In embodiments, real-time sensor data is sent to the processing subsystem 16 and processed in order to determine gob forming process parameter(s), but such data may not have to be stored in a non-transitory memory device as it may rather be retained in working memory of the processor (not shown). In embodiments, the sensor data is provided to a cloud data storage device that is implemented using non-transitory, computer-readable memory devices hosted remotely from the glass container manufacturing system 100.

The processing subsystem 16 is used for determining one or more gob forming process parameters. In particular, according to at least some embodiments, the processing subsystem 16 is used for obtaining upstream sensor data from the upstream sensor 12 and using the upstream sensor data as input into the ML model 22, which then generates an output comprised of process parameter data indicating one or more process parameters for effecting a change in gob formation. Although the present embodiment teaches use of an ML model 22, it will be appreciated that, in other embodiments, an artificial intelligence (AI) model that is not necessarily a ML model may be used. Accordingly, the discussion of the ML model 22 herein provides an example of an AI model that is used by the processing subsystem 16. In at least some embodiments, the gob formation sensor data is input into the ML model 22 along with the upstream sensor data, which may be data from one or more feeder sensors, such as, for example, those discussed above. Here, the one or more process parameters includes at least one process parameter for an attribute of the gob formation system that is different than a current or presently-used process parameter for the attribute of the gob formation system. For example, if a feeder orifice heater is at a temperature of X degrees Celsius at the present time, the ML model 22 may then determine a process parameter of X+2 degrees Celsius for the feeder orifice temperature and the gob formation system 104 may thus be configured accordingly. Such a change in feeder orifice temperature, which is discussed a bit more below, causes a change in gob formation of gobs formed by the feeder 114. Of course, this is but one example, as numerous others may be implemented as a result of the teachings herein.

The processing subsystem 16 includes the at least one processor 18 and the memory 20, which stores data accessible by the at least one processor 18. In the present embodiment, the memory 20 is used as an AI or ML model repository that stores the ML model 22, and that serves or provides the ML model 22 to the at least one processor 18 as needed. In one embodiment, the processing subsystem 16 is located at the glass container manufacturing facility whereat the glass container manufacturing system 100 is located. In another embodiment, the processing subsystem 16 is located remotely, meaning the processing subsystem 16 is located at a different location than the glass container manufacturing facility (where the glass container manufacturing system 100 is located). And, in another embodiment, the processing subsystem 16 includes a local portion (“local processing subsystem”) and a remote portion (“remote processing subsystem”). In such embodiments, multiple processors may be used as the at least one processor 18, and such processors may be located at different portions of the processing subsystem 16, such as with one or more processors at the local processing subsystem and other(s) at the remote processing subsystem. Also, although the memory 20 is shown as a single memory device in the depicted embodiment, the memory 20 may be comprised of multiple, different memory hardware devices, any of which may be co-located or remotely-located from one another, such as with a portion of the memory 20 at the local processing subsystem and another portion of the memory 20 at the remote processing subsystem, for example.

The at least one processor 18 refers to one or more electronic processors. Any one or more of these processors or other processors discussed herein may be implemented as any suitable electronic hardware that is capable of processing computer instructions and may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc.

The memory 20 refers to one or more non-transitory, computer-readable memory devices (or memories), and any of these memories or other memory discussed herein may be implemented as any suitable type of memory that is capable of storing data or information in a non-volatile manner and in an electronic form so that the stored data or information is consumable by the processor. The memory may be any a variety of different electronic memory types and may be selected based on the application in which it is to be used. Examples of types of memory that may be used include magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc.

The ML model 22 is an AI model and, more particularly, an ML model that is trained and configured to generate information indicating process parameter values or other information used for the gob forming process performed by the gob forming subsystem 104. The ML model 22 is stored in the memory 22, and executed by the at least one processor 18. The ML model 22 may be any of a variety of data-driven models, particularly those that are trained or otherwise configured through a data-driven, iterative learning process that adapts model parameters as a part thereof in order to produce a map of learned, latent relationships between the inputs and outputs. According to at least some embodiments, the ML model 22 is a neural network (NN), particularly a deep NN (DNN), although other data-driven models may be used.

Here, use of a data-driven or ML model improves upon conventional techniques for gob formation management, including those performed manually or automatically. ML models can manage higher complexity and variability in data. Such models dynamically adjust to changes in glass composition, ambient conditions, and equipment wear, ensuring consistent gob quality. Additionally, the ML approach facilitates predictive maintenance by identifying patterns indicating potential equipment failures, thereby reducing downtime and enhancing efficiency. Real-time feedback and adjustments from the data-driven model are useful for ensuring that the gobs produced consistently meet desired specifications with minimal manual intervention. This not only improves the quality and uniformity of the glass gobs, but also allows for more flexible and responsive manufacturing processes, ultimately leading to higher productivity and reduced operational costs.

The ML approach enables easy and ready adaptation of its weights so that it may be retrained and re-deployed to account for changes or “drift” that may have occurred due to, for example, wear on the gob forming equipment 108. Further, the ML approach also provides a framework that is usable for generating an ML model for a particular, desired gob shape and/or using a particular set of sensor data or other inputs. For example, a plurality of ML models may be configured through training each ML model using a different set of training data, where the different set of training data (when used in connection with an ML model of a plurality of ML models) refers to a training data set that is different in its training data entries than from other training data entries of the other ML models of the plurality of ML models. For example, in one embodiment, a first ML model is trained for use with a first gob makeup, and a second ML model is trained for use with a second gob makeup. As used herein, “gob makeup” refers to the physical formation of a gob, including its shape and its universal, physical characteristics, such as weight, mass, temperature, viscosity, density, etc., as specified by a user/operator of the glass container manufacturing system 100. A longneck beer bottle uses a different gob makeup than a half-gallon-sized, handleware jug, for example. And, in some embodiments, different ML models are trained for use in the same gob forming process, but using different equipment (on a different line of the glass container manufacturing facility); for example, a first ML model is trained for a first gob makeup and using a first set of gob formation equipment, and a second ML model is trained for the first gob makeup and using a second set of gob formation equipment that is different from the first set of gob formation equipment. This allows taking into consideration intricacies or other unique attributes of the actual gob formation equipment and environment for and in which the ML model is to be used.

The HMI output device 24 is an HMI that is used for communicating information from a machine (here, the processing subsystem 16) to a human, such as an operator of the gob forming subsystem 104. Examples of HMI output devices include a computer monitor or electronic display screen or projector (collectively, referred to herein as an “electronic display”), and an audio speaker, although other devices may be used in other embodiments. In one embodiment where the HMI output device 24 is an electronic display such as a computer monitor, a graphical user interface (GUI) is presented on the electronic display for viewing by the operator of the gob forming subsystem 104. The GUI may present various information, including, for example, gob forming process parameter(s) determined by the processing subsystem 16. In one embodiment, the system 10 further includes an HML input device, which is used for communicating information to a machine (here, the processing subsystem 16) from a human, such as the operator of the gob forming subsystem 104. In embodiments, the GUI displays the gob forming process parameter(s) and allows the operator or user to modify the process parameter(s), such as by (for example) finetuning or otherwise adjusting parameter values, and/or to confirm that the gob formation system 104 is to be configured according to the gob forming process parameter(s).

The gob forming subsystem controller 26 is an electronic control unit (ECU) or controller that is used for controlling one or more aspects of the gob forming process performed by the gob forming subsystem 104. Non-limiting examples of a gob forming subsystem controller include a temperature controller of the glass melting apparatus 110, a temperature controller of the forehearth 112, a glass level controller of the glass melting apparatus 110, a glass level controller of the forehearth 112, other temperature controller of the gob forming subsystem 104, viscosity controller of the gob forming subsystem 104, a glass homogeneity controller (e.g., controller for controlling mechanical stirrers or bubblers), a molten glass flow controller (e.g., flow controllers located at the entrance of the feeder 114), a plunger motion controller that controls stroke, trajectory, and/or other motion characteristics of a plunger of the feeder 114, a shear blade timing controller that controls shear blade timing of a shear blade of the feeder 114, an ambient or atmospheric temperature or climate controller (e.g., a temperature and/or humidity of the gob forming subsystem 104), and a heater controller that controls temperature of a surface or area over or through which molten glass flows when in the gob forming subsystem 104 (e.g., a heater of a tubular region of the feeder 114 through which molten glass flows, a heater at an orifice of the feeder 114 through which molten glass flows).

The gob forming subsystem controller 26 receives the process parameter(s) from the processing subsystem 16, and this may be in the form of control data that is configured specifically for a particular controller to which the process parameter(s) pertain. For example, a resistance heater used for heating an orifice of the feeder may be provided a power value (example of a process parameter) indicating or controlling an amount of current and heat produced by the heater. A gob forming subsystem controller interface may be used for formatting, packaging or otherwise preparing for transport, and/or modulating data representing the process parameter(s) (referred to as “process parameter data”) so that it may be communicated from the processing subsystem 16 to the gob forming subsystem controller 26 in a form and manner that allows the controller 26 to thereby become configured according to the received process parameter(s), such as, for example, by controlling the feeder orifice heater according to the process parameter value.

With reference to FIG. 2, according to one embodiment, the feeder 114 is a gob feeder, such as the gob feeder (12) taught in U.S. Patent Application Publication 2023/0271868, which is hereby incorporated by reference in its entirety. It is noted reference numerals in parenthesis refer to components or items in another document. The discussion of the gob feeder (12) of U.S. Patent Application Publication 2023/0271868 is hereby incorporated and attributed to the feeder 114 of the gob forming subsystem 104. Accordingly, the feeder 114 may include the stirrer actuators (46), gob cutter (48), orifice pipe heaters (80), and orifice tip heaters (94) of the feeder (12) of U.S. Patent Application Publication 2023/0271868. In one embodiment, the gob forming process parameter(s) determined by the processing subsystem 16 include a process parameter for adjusting or setting the stirrer actuators (46), gob cutter (48), orifice pipe heaters (80), and orifice tip heaters (94) [referring to U.S. Patent Application Publication 2023/0271868] of the feeder 114.

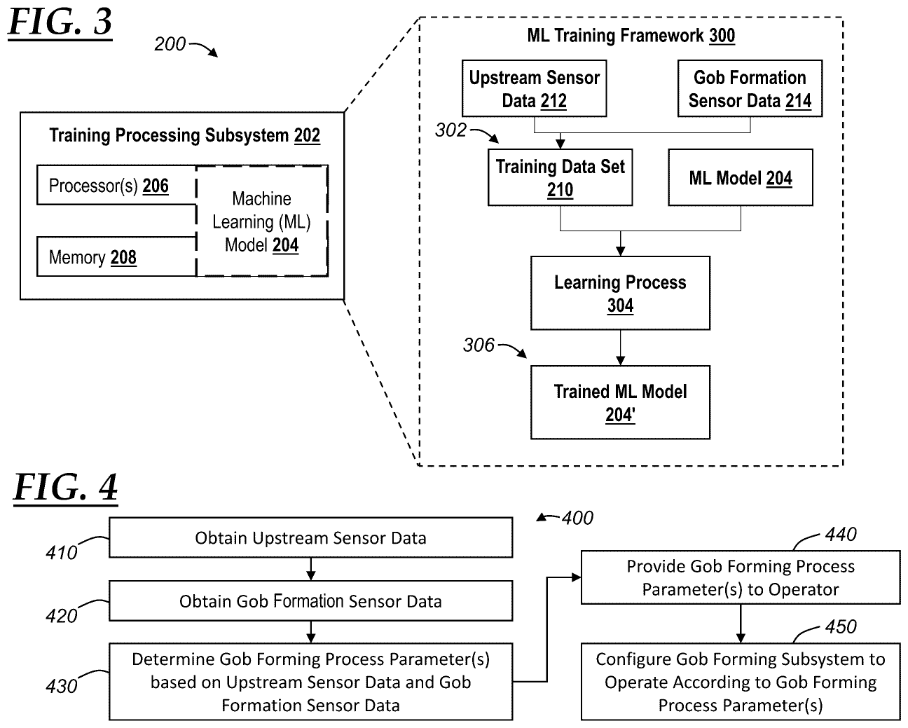

With reference to FIG. 3, there is shown a ML model training system 200 having a training processing subsystem 202 that implements a ML training framework or process 300 for training a ML model 204. The training processing subsystem 202 includes at least one processor 206 and memory 208, which are used for storing and processing (training) the ML model 204, respectively. The discussion of the processing subsystem 16 is hereby attributed to the training processing subsystem 202 to the extent that discussion is not inconsistent with the discussion and teachings of the training processing subsystem 202. The discussions of the at least one processor 18 and the memory 20 of the processing subsystem 16 are hereby attributed to the at least one processor 206 and the memory 208 of the training processing subsystem 202 to the extent that discussion is not inconsistent with the discussion and teachings of the at least one processor 206 and the memory 208. Further, the ML model 204 is a ML model that is to be trained so that it may be used as a part of a gob forming process parameter determination system, such as where the ML model 204 is trained and used as the ML model 22 of the system 10.

The ML training framework or process 300 of the present embodiment employs a reinforcement learning approach, although other ML approaches and frameworks may be used, according to other embodiments. In the present ML reinforcement learning framework 300, control parameters are dynamically adjusted based on real-time sensor data, allowing the agent to continuously learn and improve over time. By integrating upstream and formation sensors with a reinforcement learning agent, informed decisions on how to modify production conditions can be made in order to consistently meet target specifications for the gobs within a target environment.

In the present embodiment, the target environment includes the gob forming subsystem 104, the molten glass and/or other processing material of the gob forming subsystem 104, and the environment of the gob forming subsystem 104. The target environment changes dynamically in response to the agent's actions. These actions, which are adjustments to process parameter(s), alter the way the gob forming subsystem operates, whereby changes in a process parameter effects (or quite often effects at some level) a change in gob formation. The target environment feeds back new sensor data after each adjustment, providing the agent with the updated state of the process and the resulting gob. This constant feedback loop allows the environment to be the agent's primary source of information for making informed decisions.

The ML training framework 300 begins step 302 whereat a training data set 210 is prepared using upstream sensor data 212 and gob formation sensor data 214. The upstream sensor data 212 is useful as certain physical properties or characteristics of the gob forming subsystem 104 (or its environment) often vary over time, and often result in influencing gob formation. Thus, through use of the upstream sensor data, the agent can preemptively adjust the production controls (through determining process parameter(s) to use) to account for variations that could affect the quality of the output. This upstream sensor allows the agent to make more predictive, rather than reactive, decisions, at least according to embodiments.

The gob formation sensor 14 provides feedback about the physical form of the gobs, and the gob formation sensor data, which may indicate certain physical attributes of the gob. This gob formation data is useful for determining gob formation of gobs and gob formation deviance, which may be measured through comparing measured gob physical attributes (e.g., gob width, gob length, gob weight) with corresponding specified gob attributes. This gob formation data is used by the reward system in the reinforcement learning framework.

In the reinforcement learning framework of the present embodiment, the process parameters are akin to the actions that the agent can adjust in real time. In the present embodiment, the reward function is the mechanism by which the agent learns and improves its actions. It assigns values to different outcomes based on the quality of the produced gobs and the efficiency of the gob forming process. A well-crafted reward function should encourage the agent to produce gobs that meet or exceed the target specifications, while also discouraging actions that result in defective gobs or excessive resource consumption. The reward function translates the production goals into measurable outcomes that the agent can optimize over time. Through repeated interactions with the environment, the agent learns which control parameter adjustments consistently result in higher rewards, guiding the agent toward optimal gob formation strategies.

Finally, the agent itself is the core of the reinforcement learning system. The agent observes the state of the environment, which includes both upstream and gob formation sensor data, and makes decisions on how to adjust the control parameters. Over time, the agent improves its decision-making by learning from the rewards and penalties associated with its actions. The ML model 22 may be trained using reinforcement learning. Different reinforcement learning algorithms can be used depending on the complexity of the control parameters and the gob forming process. For example, algorithms like Proximal Policy Optimization (PPO) or Deep Deterministic Policy Gradient (DDPG) are effective when the action space is continuous, allowing for fine adjustments to the control settings such as feeder orifice temperature and plunger stroke. In simpler cases where the control parameters can be discretized, algorithms like Deep Q-Networks (DQN) might be more appropriate. Regardless of the algorithm, the agent's role is to continuously learn from its interactions with the environment and improve the overall gob forming process.

After the training data set 210 is prepared, a learning process 304 is performed for the ML model 204 using the training data set 210. The learning process 304 of the present embodiment is a reinforcement learning operation whereupon the agent iteratively interacts with the environment, observes the outcomes, and updates its control strategies, corresponding to the process parameter(s), based on the reward feedback it receives.

After the ML model 204 is sufficiently trained, which may be determined through validation testing, the ML model 204 is considered a trained ML model 204′, as indicated in FIG. 3. The trained ML model 204′ may be stored in an ML model repository and used for gob forming process parameter determination, as described herein.

With reference now to FIG. 4, there is shown an embodiment of a method 400 of determining one or more process parameters for a gob forming subsystem. The method 400 is performed by the processing subsystem 16, according to at least one embodiment. Although the steps of the method 400 are described as being performed in a particular order, the steps of the method 400 may be performed in any technically-feasible order, such as where step 410 and step 420 are carried out concurrently or where step 420 is carried out before step 410.

The method 400 begins with step 410, wherein upstream sensor data representing information captured by one or more upstream sensors (or one or more sensors installed upstream of a feeder of the gob forming subsystem). The upstream sensor 12 captures sensor data of the gob forming subsystem 104, the molten glass or material therein, and/or its environment, and this upstream sensor data is then provided to the processing subsystem 16. The upstream sensor data may be stored in memory, such as the memory 20 of the processing subsystem 16. The method 400 continues to step 420.

In step 420, wherein gob formation sensor data is obtained, wherein the gob formation data is data concerning one or more physical attributes of one or more gobs produced by the gob forming subsystem. The gob formation sensor 14 captures sensor data of the one or more gobs, such as through using a camera to capture images of gobs and then processing said images to determine one or more measurement values of one or more physical dimensions (e.g., gob length, gob width) and/or other physical aspects (e.g., gob drop angle, gob temperature, gob viscosity, gob density, gob weight or mass). This gob formation sensor data is then provided to the processing subsystem 16, and the gob formation sensor data may be stored in memory, such as the memory 20 of the processing subsystem 16. The method 400 continues to step 430.

In step 430, one or more gob forming process parameters are determined as a result of executing an artificial intelligence (AI) (e.g., machine learning (ML)) model that takes, as input, the upstream sensor data and that generates, as output, process parameter data representing the one or more gob forming process parameters. In one embodiment, the processing subsystem 16 executes the ML model 22 using the upstream sensor data and the gob formation sensor data as input. For example, in an embodiment where the ML model 22 is implemented using a neural network, execution of the ML model 22 includes performing a forward pass of the neural network so as to generate an output. The processing subsystem 16, as a result of executing the ML model 22, generates an output indicating process parameter(s) for gob formation, and this output may be referred to as process parameter data. In one embodiment, gob loading information may be determined by a gob loading sensor and then used as input into the AI model (in conjunction with or in lieu of the gob forming data). The method 400 continues to step 440.

In step 440, the one or more gob forming process parameters are provided to an operator. The HMI output device 24, which may be an electronic display of a personal computer (PC), for example, is used to provide the gob forming process parameter(s) to the operator so that the operator may view and consider the gob forming process parameter(s). In one embodiment, the operator is able to provide input into the processing subsystem 16, such as through use of a computer mouse, keyboard, or microphone, for example. This operator input may be a confirmation to configure the gob forming subsystem 104 according to the gob forming process parameter(s). In an embodiment, the operator is able to use a computer mouse or keyboard (or other computer peripheral or HMI input device) to modify and/or otherwise adjust the gob forming process parameter(s), and then the gob forming subsystem 104 may be configured according to these operator-tuned gob forming process parameter(s).

Such embodiments, referring to those where an operator adjusts and/or confirms the gob forming process parameter(s) before said parameter(s) are used for configuring the gob forming subsystem, are referred to as “semi-automatic” in the sense that the process parameter(s) for the system are determined automatically while also having to have manual confirmation before configuring the system according to the process parameter(s). In other embodiments, the method 400 is “automatic” in that no manual confirmation of the determined process parameter(s) is needed prior to the system being configured according to the determined process parameter(s). Such automatic methods may be performed by an automatic gob forming adjustment system that implements automatic determination of gob forming process parameters for a gob forming subsystem and configuration of the gob forming subsystem according to the gob forming process parameters. The method 400 continues to step 450.

In step 450, the gob forming subsystem is configured according to the gob forming process parameter(s). In one embodiment, the processing subsystem 16 communicates the process parameter(s) to the gob forming subsystem controller 26, which adjusts the relevant components of the gob forming subsystem 104. For instance, the feeder orifice heater may be set to a new temperature, the plunger stroke may be adjusted, or the shear blade timing may be altered. These adjustments are made to ensure that the gob forming process produces gobs with the desired physical characteristics, such as weight, length, and shape, thereby optimizing the quality and efficiency of the glass container manufacturing process. The method 400 ends.

According to at least some embodiments, the method 400 is performed continuously so as to continuously determine updated process parameter(s) that may be provided to an operator (via the HMI output device 24) and/or used by the gob forming subsystem 104 for its operation.

As used in herein, the terminology “for example,” “e.g.,” for instance,” “like,” “such as,” “comprising,” “having,” “including,” and the like, when used with a listing of one or more elements, is to be construed as open-ended, meaning that the listing does not exclude additional elements. Also, as used herein, the term “may” is an expedient merely to indicate optionality, for instance, of a disclosed embodiment, element, feature, or the like, and should not be construed as rendering indefinite any disclosure herein.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. The present disclosure is intended to embrace all such embodiments and modifications of the subject matter of this application, and equivalents thereto, as fall within the broad scope of the accompanying claims.

1. A method of determining process parameters for a gob forming subsystem (106) of a glass container manufacturing system, comprising:
obtaining upstream sensor data representing information captured by one or more sensors installed upstream of a feeder of the gob forming subsystem; and
determining one or more gob forming process parameters as a result of executing an artificial intelligence (AI) model that takes, as input, the upstream sensor data and that generates, as output, process parameter data representing the one or more gob forming process parameters.

2. The method of claim 1, wherein, when the gob forming subsystem is configured according to the one or more gob forming process parameters, gob formation of gobs produced by the gob forming subsystem is altered so as to effect a change to one or more physical properties of the gobs.

3. The method of claim 1, further comprising obtaining gob formation sensor data of one or more gobs produced by the gob forming subsystem, and wherein the one or more gob forming process parameters are determined based on the gob formation sensor data.

4. The method of claim 3, wherein the gob formation sensor data is or includes a measurement value of a physical dimension or other physical aspect of the one or more gobs, including gob weight, gob length, gob width, gob diameter, gob surface temperature, gob viscosity, gob velocity, gob acceleration, and/or gob drop angle.

5. The method of claim 1, wherein the gob forming process parameter(s) include temperature of molten glass in a glass melting apparatus and/or a process parameter for controlling a feeder orifice heater of the gob forming subsystem.

6. The method of claim 1, wherein the gob forming process parameter(s) include at least one of the following: a process parameter for controlling plunger stroke, trajectory, or other motion characteristic of the feeder of the gob forming subsystem, or a process parameter for controlling shear blade timing of the feeder of the gob forming subsystem.

7. The method of claim 1, wherein batch composition data is used as input into the AI model in order to generate the process parameter data.

8. The method of claim 1, wherein the one or more sensors includes a feeder sensor, and wherein the feeder sensor is used by the feeder and/or at the feeder to measure operational information of the feeder and/or molten glass at the feeder prior to gob formation.

9. The method of claim 1, wherein the process parameter data is automatically provided to a gob forming subsystem controller that uses the process parameter data for adjusting the gob forming process to operate according to the gob forming process parameter(s).

10. The method of claim 1, wherein the AI model is a machine learning (ML) model, and wherein the ML model is trained using reinforcement learning using Proximal Policy Optimization (PPO), Deep Deterministic Policy Gradient (DDPG), and/or Deep Q-Networks (DQN).

11. A system, comprising:
at least one processor;
memory storing computer instructions that, when executed by the at least one processor, cause the system to:
obtain upstream sensor data representing information captured by one or more sensors installed upstream of a feeder of a gob forming subsystem; and
determine one or more gob forming process parameters as a result of executing an artificial intelligence (AI) model that takes, as input, the upstream sensor data and that generates, as output, process parameter data representing the gob forming process parameters.

12. The system of claim 11, wherein, when the gob forming subsystem is configured according to the one or more gob forming process parameters, gob formation of gobs produced by the gob forming subsystem is altered so as to effect a change to one or more physical properties of the gobs.

13. The system of claim 11, wherein the system is further configured to obtaining gob formation sensor data of one or more gobs produced by the gob forming subsystem, and wherein the one or more gob forming process parameters are determined based on the gob formation sensor data.

14. The system of claim 13, wherein the gob formation sensor data is or includes a measurement value of a physical dimension or other physical aspect of the one or more gobs, including gob weight, gob length, gob width, gob diameter, gob surface temperature, gob viscosity, gob velocity, gob acceleration, and/or gob drop angle.

15. The system of claim 11, wherein the one or more gob forming process parameters include temperature of molten glass in a glass melting apparatus and/or a process parameter for controlling a feeder orifice heater of the gob forming subsystem.

16. The system of claim 11, wherein the one or more gob forming process parameters include at least one of the following: a process parameter for controlling plunger stroke, trajectory, or other motion characteristic of a feeder of the gob forming subsystem, or a process parameter for controlling shear blade timing of a feeder of the gob forming subsystem.

17. The system of claim 11, wherein batch composition data is used as input into the AI model in order to generate the process parameter data.

18. The system of claim 11, wherein the one or more sensors includes a feeder sensor, and wherein the feeder sensor is used by the feeder and/or at the feeder to measure operational information of the feeder and/or molten glass at the feeder prior to gob formation.

19. The system of claim 11, wherein the process parameter data is automatically provided to a gob forming subsystem controller that uses the process parameter data for adjusting a gob forming process to operate according to the one or more gob forming process parameters.

20. The system of claim 11, wherein the AI model is a machine learning (ML) model, and wherein the ML model is trained using reinforcement learning using Proximal Policy Optimization (PPO), Deep Deterministic Policy Gradient (DDPG), and/or Deep Q-Networks (DQN).
